(19) United States
(12) Patent Application Publication
(10) Pub. No.: US 2023/0215100 A1
(43) Pub. Date: Jul. 6, 2023

(54) METHOD AND APPARATUS FOR MATCHING 3D POINT CLOUD USING A LOCAL GRAPH

(71) Applicant: ELECTRONICS AND TELECOMMUNICATIONS RESEARCH INSTITUTE, Daejeon (KR)

(72) Inventors: Man Hee LEE, Daejeon (KR); Chang Joon PARK, Daejeon (KR)

(73) Assignee: ELECTRONICS AND TELECOMMUNICATIONS RESEARCH INSTITUTE, Daejeon (KR)

(21) Appl. No.: 18/084,352

(22) Filed: Dec. 19, 2022

(30) Foreign Application Priority Data
Dec. 30, 2021 (KR) 10-2021-0192744

(51) Int. Cl. G06T 19/00; G06F 18/22

(52) U.S. Cl. CPC G06T 19/00; G06F 18/22; G06T 2210/56

(57) ABSTRACT

A device that executes a program stored in the memory to perform generating a local graph for the 3D point cloud based on distances and angles between 3D points in the 3D point cloud; matching the local graph using a similarity function and determining a feature matching pair in a matched local graph; and estimating a rigid body transformation matrix using the feature matching pair is provided.

### CROSS REFERENCE TO RELATED APPLICATIONS

The present application is based on and claims the benefit of priority to Korean Patent Application Number 10-2021-0192744, filed on Dec. 30, 2021 in the Korean Intellectual Property Office, the entire disclosure of which is incorporated herein by reference.

### TECHNICAL FIELD

The present disclosure relates to a method and apparatus for matching a three-dimensional (3D) point cloud using a local graph.

### BACKGROUND

3D point cloud matching generally includes extracting and describing features for a 3D point and obtaining R and t of a rigid body transformation by matching the extracted features.

The describing of the features for a 3D point may be divided into a conventional sampling-based feature description method and a learning-based feature description method, similar to a 2D image, and recently, the learning-based feature description method has exhibited good performance.

The obtaining of a rigid body transformation by matching 3D features may be classified into traditional methods using RANSAC and P3P, and learning-based methods, such as recent PointDSC.

In RANSAC, after a rigid body transformation is calculated using an arbitrary correspondence point among input matching pairs, a geometric error for all correspondence points is calculated, and this calculation process is repeated to estimate a rigid body transformation that minimizes error. Although this method has been used in many fields for a long time, obtaining the best results is not guaranteed. In particular, RANSAC has a disadvantage that the number of iterations increases or finding a correct value is difficult when the ratio of inlier matched pairs is small.

The learning-based rigid body transformation estimation techniques, such as PointDSC, may obtain more accurate results than existing methods, such as RANSAC, but has a disadvantage that performance deteriorates when the number of inliers is small and is dependent on training data, like existing methods.

### SUMMARY

An embodiment provides an apparatus for matching a three-dimensional (3D) point cloud.

Another embodiment provides a method for matching a 3D point cloud.

According to an embodiment, an apparatus for matching a three-dimensional (3D) point cloud is provided. The apparatus includes a processor and a memory, wherein the processor executes a program stored in the memory to perform an operation of generating a local graph for the 3D point cloud based on distances and angles between 3D points in the 3D point cloud; and an operation of estimating a rigid body transformation matrix for matching the 3D point cloud using the local graph.

The processor may execute the program to further perform an operation of obtaining the 3D point cloud from at least one sensor.

The processor may execute the program to further perform an operation of generating a feature descriptor of each of the 3D points in the 3D point cloud; and calculating descriptor differences between all 3D points in the 3D point cloud.

When performing the operation of generating the local graph for the 3D point cloud based on the distances and angles between the 3D points in the 3D point cloud, the processor may perform calculating an overlapping region between the 3D points in the 3D point cloud; and including a 3D point determined not to overlap in a graph node.

When performing the operation of generating the local graph for the 3D point cloud based on the distances and angles between the 3D points in the 3D point cloud, the processor may further perform an operation of generating the local graph based on a relationship between a first 3D point, among 3D points included in the graph node, and remaining 3D points, excluding the first 3D point, among the 3D points included in the graph node.

The local graph may include edges between the first 3D point and the remaining 3D points.

The local graph may include attributes of the first 3D point, and the attributes of the first 3D point may include at least one of distances between the first 3D point and the remaining 3D points, angles of the remaining 3D points with respect to the first 3D point, and differences between a feature descriptor of the first 3D point and feature descriptors of the remaining 3D points.

When performing the operation of estimating a rigid body transformation matrix for matching the 3D point cloud using the local graph, the processor may perform an operation of matching the local graph using a similarity function and determining a feature matching pair in a matched local graph; and an operation of estimating the rigid body transformation matrix using the feature matching pair.

According to another embodiment, a method for matching a three-dimensional (3D) point cloud is provided. The method includes: generating a local graph for the 3D point cloud based on distances and angles between 3D points in the 3D point cloud; and estimating a rigid body transformation matrix for matching the 3D point cloud using the local graph.

The method may further include: obtaining the 3D point cloud from at least one sensor.

The method may further include: generating a feature descriptor of each of the 3D points in the 3D point cloud; and calculating descriptor differences between all 3D points in the 3D point cloud.

The generating of the local graph for the 3D point cloud based on the distances and angles between the 3D points in the 3D point cloud may include: calculating an overlapping region between the 3D points in the 3D point cloud; and including a 3D point determined not to overlap in a graph node.

The generating of the local graph for the 3D point cloud based on the distances and angles between the 3D points in the 3D point cloud may further include: generating the local graph based on a relationship between a first 3D point, among 3D points included in the graph node, and remaining 3D points, excluding the first 3D point, among the 3D points included in the graph node.

The local graph may include edges between the first 3D point and the remaining 3D points.

The local graph may include attributes of the first 3D point, and the attributes of the first 3D point may include at least one of distances between the first 3D point and the remaining 3D points, angles of the remaining 3D points with respect to the first 3D point, and differences between a feature descriptor of the first 3D point and feature descriptors of the remaining 3D points.

The estimating of a rigid body transformation matrix for matching the 3D point cloud using the local graph may include: matching the local graph using a similarity function and determining a feature matching pair in a matched local graph; and estimating the rigid body transformation matrix using the feature matching pair.

Performance and accuracy of 3D point cloud matching may be improved by describing features of a 3D point cloud using a local graph and matching the features using a similarity function of the local graph.

### BRIEF DESCRIPTION OF THE DRAWINGS

FIG. 1 is a flowchart illustrating a method for matching a 3D point cloud using a local graph according to an embodiment.

FIG. 2 is a block diagram illustrating an apparatus for matching a 3D point cloud according to an embodiment.

### DETAILED DESCRIPTION

In the following detailed description, only certain embodiments of the present disclosure have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Throughout the specification, when a part is referred to “include” a certain element, it means that it may further include other elements rather than exclude other elements, unless specifically indicates otherwise.

In the description, expressions described in the singular in this specification may be interpreted as the singular or plural unless an explicit expression, such as “one” or “single” is used.

In this specification, “and/or” includes each and every combination of one or more of the mentioned elements.

Terms, such as first, second, and the like may be used to describe various components and the components should not be limited by the terms. The terms are used only to discriminate one constituent element from another component. For example, a first component may be referred to as a second component, and similarly, the second component may be referred to as the first component without departing from the scope of the present disclosure.

In the flowchart described with reference to the drawings in this specification, the order of operations may be changed, several operations may be merged, a certain operation may be divided, and a specific operation may not be performed.

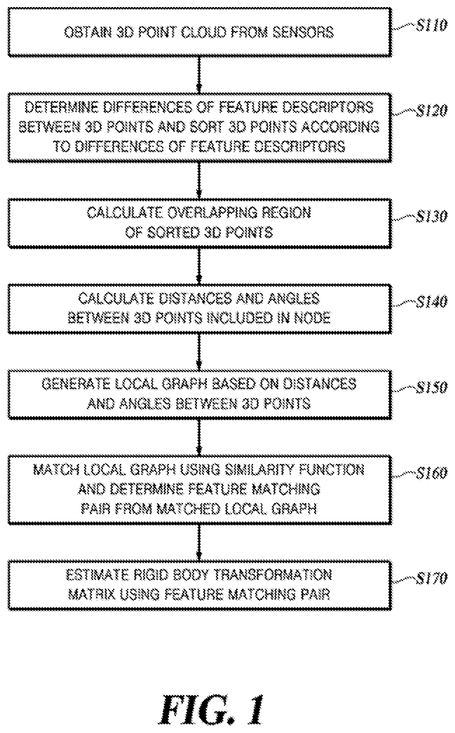

FIG. 1 is a flowchart illustrating a method for matching a 3D point cloud using a local graph according to an embodiment.

Referring to FIG. 1, an apparatus for matching a 3D point cloud using a local graph according to an embodiment may obtain a 3D point cloud from various sensors (e.g., a Lidar sensor, depth sensor, RGB-D sensor) (S110).

The matching apparatus according to an embodiment may generate feature descriptors for the obtained 3D point cloud, calculate descriptor differences between all 3D points in the obtained 3D point cloud, and sort 3D points in the 3D point cloud according to the calculated descriptor differences (S120). At this time, the matching apparatus may include one 3D point vᵢ in a node Vi of the graph using a 3D feature descriptor. In addition, the matching apparatus may calculate feature descriptor differences between the 3D point vᵢ and all other 3D points. The matching apparatus according to an embodiment may sort the 3D points in descending order according to the calculated differences of the feature descriptors.

Next, the matching apparatus according to an embodiment may calculate an overlapping region of the sorted 3D points (S130). The matching apparatus according to an embodiment may calculate an overlapping region between each 3D point and another 3D point within a distance Tₒ from each 3D point. Here, the matching apparatus may calculate the overlapping region in order of the 3D points sorted in descending order. Also, the matching apparatus may include n number of non-overlapping points vⱼ, among 3D points, in the node Vi of the graph. For example, when 15 3D points sorted in descending order are included in the node Vi of the graph, an overlapping region between a 16-th 3D point and the 15 points included in the graph node may be compared, and when a distance between the points is equal to or less than a predetermined threshold value, the 16-th 3D point may be determined to have an overlapping region.

Next, the matching apparatus according to an embodiment may calculate distances and angles between the 3D point vᵢ and all 3D points vⱼ included in the node Vi of the graph (S140). In addition, the matching apparatus according to an embodiment may generate a local graph Gᵢ having an edge Eᵢ based on the distances and angles between the 3D points in the node Vi of the graph (S150). The local graph Gᵢ may be in the form of a tree of level 1 and may be expressed as Equation 1 below.

Gᵢ=(Vᵢ,Eᵢ,Aᵢ) Equation 1

In Equation 1, the edge Eᵢ may be a connection between the 3D point vᵢ and another 3D point vⱼ included in the graph node Vi. Also, in Equation 1, Aᵢ is an attribute of the 3D point vᵢ. Aᵢ may include a distance between the 3D point vᵢ (i.e., a reference node in the graph) and another 3D point vⱼ, an angle of another 3D point vⱼ with respect to the 3D point vᵢ, and a feature descriptor difference between the 3D point vᵢ and the another 3D point vⱼ.

The matching apparatus according to an embodiment may match all local graphs Ω={G₁, G₂, . . . , G_{M}} by using a similarity function S(i,j), and determine a feature matching pair in the matched local graphs (S160). The similarity function may be expressed as Equation 2 below.

$$S ( i , j ) = {\sum }_{p} {max}_{q} ( {N}_{i} ( \frac{{l}_{ip} - {l}_{jq}}{{l}_{ip}} ) {N}_{θ} ( {θ}_{ip} - {θ}_{jq} ) {N}_{d} ( {d}_{ip} - {d}_{jq} ) ) \qquad Equation 2$$

Thereafter, the matching apparatus according to an embodiment may estimate a rigid body transformation matrix using the determined feature matching pair (S170).

As described above, the matching performance of the 3D point cloud may be improved by describing the features of the 3D point cloud using the local graph and matching the features using the similarity function of the local graph. That is, the accuracy of feature matching may be improved by using the geometric features of the 3D point cloud.

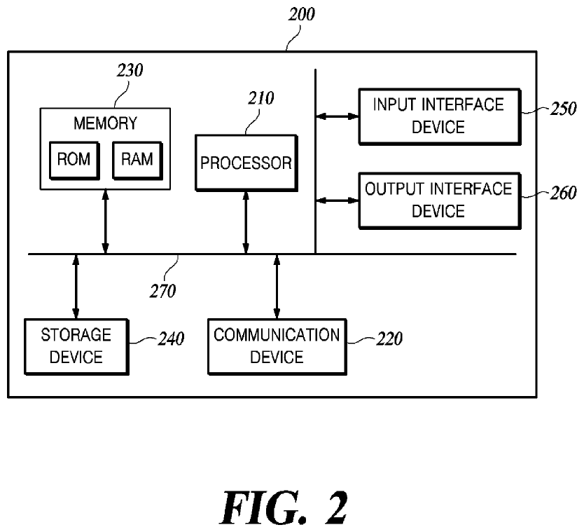

FIG. 2 is a block diagram illustrating an apparatus for matching a 3D point cloud according to an embodiment.

The matching apparatus according to an embodiment may be implemented as a computer system, for example, a computer-readable medium. Referring to FIG. 2, a computer system 200 may include at least one of a processor 210, a memory 230, an input interface device 250, an output interface device 260, and a storage device 240 communicating through a bus 270. The computer system 200 may also include a communication device 220 coupled to a network. The processor 210 may be a central processing unit (CPU) or a semiconductor device that executes instructions and/or programs stored in the memory 230 or the storage device 240. The memory 230 and the storage device 240 may include various types of volatile or non-volatile storage mediums. For example, the memory may include read only memory (ROM) and random access memory (RAM). In an embodiment of the present description, the memory may be located inside or outside the processor, and the memory may be connected to the processor through various known means. The memory may be a volatile or non-volatile storage medium in various forms, and may include, for example, ROM or RAM.

Accordingly, embodiments may be implemented as a method implemented in a computer or as a non-transitory computer-readable medium in which computer-executable instructions are stored. In an embodiment, when executed by a processor, computer readable instructions may perform a method according to at least one aspect of the present disclosure.

The communication device 220 may transmit or receive a wired signal or a wireless signal.

Meanwhile, the embodiments are not implemented only through the apparatus and/or method described so far and may be implemented through a program that realizes functions corresponding to the configuration of the embodiments or a recording medium on which the program is recorded. These embodiments may be easily implemented by those skilled in the art to which the present invention pertains from the description of the embodiments described above. Specifically, the method (e.g., method, etc.) according to the embodiments may be implemented in the form of program instructions that may be executed by various computer means and may be recorded on a computer-readable medium. The computer-readable medium may include program instructions, data files, data structures, etc. alone or in combination. The program instructions recorded on the computer readable medium may be specially designed and configured for the embodiments or may be known and usable to those skilled in the art of computer software. The computer-readable recording medium may include a hardware device configured to store and execute program instructions. For example, the computer-readable recording medium may include magnetic media, such as hard disks, floppy disks, and magnetic tapes, optical media, such as CD-ROMs and DVDs, magneto-optical media, such as floptical disks, ROM, RAM, flash memory, or the like. The program instructions may include high-level language codes that may be executed by a computer through an interpreter, as well as machine language codes generated by a compiler.

While the invention has been described with reference to exemplary embodiments thereof, one of ordinary skill in the art would understand that various changes in form and details may be made therein without departing from the idea and scope of the invention as defined by the claims and equivalents thereof

What is claimed is:

1. An apparatus for matching a three-dimensional (3D) point cloud, the apparatus comprising:
a processor and a memory,
wherein the processor executes a program stored in the memory to perform
an operation of generating a local graph for the 3D point cloud based on distances and angles between 3D points in the 3D point cloud; and
an operation of estimating a rigid body transformation matrix for matching the 3D point cloud using the local graph.

2. The apparatus of claim 1, wherein the processor executes the program to further perform an operation of obtaining the 3D point cloud from at least one sensor.

3. The apparatus of claim 1, wherein
the processor executes the program to further perform an operation of
generating a feature descriptor of each of the 3D points in the 3D point cloud; and
calculating descriptor differences between all 3D points in the 3D point cloud.

4. The apparatus of claim 3, wherein,
when performing the operation of generating the local graph for the 3D point cloud based on the distances and the angles between the 3D points in the 3D point cloud,
the processor performs calculating an overlapping region between the 3D points in the 3D point cloud; and
including a 3D point determined not to overlap in a graph node.

5. The apparatus of claim 4, wherein,
when performing the operation of generating the local graph for the 3D point cloud based on the distances and the angles between the 3D points in the 3D point cloud,
the processor further performs an operation of generating the local graph based on a relationship between a first 3D point, among 3D points included in the graph node, and remaining 3D points, excluding the first 3D point, among the 3D points included in the graph node.

6. The apparatus of claim 5, wherein the local graph includes edges between the first 3D point and the remaining 3D points.

7. The apparatus of claim 5, wherein
the local graph includes attributes of the first 3D point, and
the attributes of the first 3D point include at least one of distances between the first 3D point and the remaining 3D points, angles of the remaining 3D points with respect to the first 3D point, and differences between a feature descriptor of the first 3D point and feature descriptors of the remaining 3D points.

8. The apparatus of claim 1, wherein
when performing the operation of estimating the rigid body transformation matrix for matching the 3D point cloud using the local graph,
the processor performs
an operation of matching the local graph using a similarity function and determining a feature matching pair in a matched local graph; and
an operation of estimating the rigid body transformation matrix using the feature matching pair.

9. A method for matching a three-dimensional (3D) point cloud, the method comprising:
generating a local graph for the 3D point cloud based on distances and angles between 3D points in the 3D point cloud; and
estimating a rigid body transformation matrix for matching the 3D point cloud using the local graph.

10. The method of claim 9, further comprising:
obtaining the 3D point cloud from at least one sensor.

11. The method of claim 9, further comprising:
generating a feature descriptor of each of the 3D points in the 3D point cloud; and
calculating descriptor differences between all 3D points in the 3D point cloud.

12. The method of claim 11, wherein
the generating of the local graph for the 3D point cloud based on the distances and the angles between the 3D points in the 3D point cloud includes:
calculating an overlapping region between the 3D points in the 3D point cloud; and
including a 3D point determined not to overlap in a graph node.

13. The method of claim 12, wherein
the generating of the local graph for the 3D point cloud based on the distances and the angles between the 3D points in the 3D point cloud further includes:
generating the local graph based on a relationship between a first 3D point, among 3D points included in the graph node, and remaining 3D points, excluding the first 3D point, among the 3D points included in the graph node.

14. The method of claim 13, wherein the local graph includes edges between the first 3D point and the remaining 3D points.

15. The method of claim 13, wherein
the local graph includes attributes of the first 3D point, and
the attributes of the first 3D point include at least one of distances between the first 3D point and the remaining 3D points, angles of the remaining 3D points with respect to the first 3D point, and differences between a feature descriptor of the first 3D point and feature descriptors of the remaining 3D points.

16. The method of claim 9, wherein
the estimating of the rigid body transformation matrix for matching the 3D point cloud using the local graph includes:
matching the local graph using a similarity function and determining a feature matching pair in a matched local graph; and
estimating the rigid body transformation matrix using the feature matching pair.
